(19) United States
(12) Patent Application Publication
(10) Pub. No.: US 2017/0088457 A1
(43) Pub. Date: Mar. 30, 2017

(54) METHOD OF MANUFACTURING GLASS SUBSTRATE WITH THROUGH HOLE, METHOD OF MANUFACTURING GLASS SUBSTRATE INCLUDING THROUGH ELECTRODE, AND METHOD OF MANUFACTURING INTERPOSER

(71) Applicant: Asahi Glass Company, Limited, Chiyoda-ku (JP)

(72) Inventor: Shigetoshi MORI, Chiyoda-ku (JP)

(73) Assignee: Asahi Glass Company, Limited, Chiyoda-ku (JP)

(21) Appl. No.: 15/269,008

(22) Filed: Sep. 19, 2016

(30) Foreign Application Priority Data
Sep. 25, 2015 (JP) 2015-188844
Feb. 29, 2016 (JP) 2016-037545

(51) Int. Cl. C03C 15/00; C03B 33/08

(52) U.S. Cl. CPC C03C 15/00; C03B 33/082

(57) ABSTRACT

Disclosed is a method of manufacturing a glass substrate with a through hole, the glass substrate having a thickness of θ_{f}, the method including (1) adjusting a first thickness θ₁ of the glass substrate having first and second surfaces facing each other to be a second thickness θ₂ (θ₂<θ₁); (2) forming one or more through holes in the glass substrate by irradiating a laser beam from the first surface of the glass substrate; and (3) wet-etching the glass substrate with the through hole to adjust a size of the through hole to be a predetermined size, so that the thickness of the glass substrate is adjusted from θ₂ to the target value of θ_{f}.

### CROSS-REFERENCE TO RELATED APPLICATION

The present application is based on and claims the benefit of priority of Japanese Patent Application No. 2015-188844, filed on Sep. 25, 2015, and Japanese Patent Application No. 2016-037545, filed on Feb. 29, 2016, the entire contents of which are hereby incorporated by reference.

### BACKGROUND OF THE INVENTION

1. Field of the Invention

The present invention relates to a method of manufacturing a glass substrate with a through hole.

2. Description of the Related Art

A technique has been known, so far, where one or more through holes are formed in a glass substrate by irradiating a laser beam generated from a laser light source onto the glass substrate.

Usually, for manufacturing a glass substrate with a through hole,

(1) a glass substrate is prepared, which has first and second surfaces, and a first thickness; and

(2) a laser beam is irradiated from the first surface of the glass substrate, and a through hole is formed.

Additionally, if the size of the obtained through hole is insufficient,

(3) the glass substrate with the through hole is further wet etched to enlarge the size of the through hole.

Here, if the process of (3) is applied, though the through hole can be adjusted to be have a size in a desired range, at the same time, the thickness of the glass substrate is decreased. Consequently, a problem arises where the final thickness of the glass substrate is deviated from a predetermined range.

Furthermore, if, at the process of (2), an attempt is made to form, in advance, a through hole with a size that is close to a predetermined size, a likelihood that a crack is generated in the glass substrate is increased, and a yield rate of manufacturing is lowered.

There is a need for a method with which a glass substrate having a desired thickness provided with a through hole having a desired size can be manufactured at a high yield rate.

### SUMMARY OF THE INVENTION

According to an aspect of the present invention, there is provided a method of manufacturing a glass substrate with a through hole, the glass substrate having a thickness of θ_{f}, the method including (1) adjusting a first thickness θ₁ of the glass substrate having first and second surfaces facing each other to be a second thickness θ₂ (θ₂<θ₁); (2) forming one or more through holes in the glass substrate by irradiating a laser beam from the first surface of the glass substrate; and (3) wet-etching the glass substrate with the through hole to adjust a size of the through hole to be a predetermined size, so that the thickness of the glass substrate is adjusted from θ₂ to a target value of θ_{f}.

According to an aspect of the present invention, a method can be provided with which a glass substrate having a desired thickness provided with a through hole having a desired size can be manufactured with a high yield rate.

Other objects, features and advantages of the present invention will become more apparent from the following detailed description when read in conjunction with the accompanying drawings.

### BRIEF DESCRIPTION OF THE DRAWINGS

FIGS. 1A, 1B, and 1C are diagrams schematically illustrating respective processes of a method of manufacturing a glass substrate with a through hole according to related art;

FIG. 2 is a diagram schematically illustrating a flow of a method of manufacturing the glass substrate with the through hole according to an embodiment of the present invention;

FIGS. 3A, 3B, 3C, and 3D are diagrams schematically illustrating respective processes of the method of manufacturing the glass substrate with the through hole according to the embodiment of the present invention;

FIG. 4A is a cross-sectional view schematically illustrating a state where a plurality of through holes is formed in the glass substrate;

FIG. 4B is a cross-sectional view schematically illustrating a state after the glass substrate is wet-etched;

FIG. 5 is a diagram showing a relationship between diameters of first and second openings of the through holes in the glass substrate, which is manufactured by the method according to the related art, and a thickness of the glass substrate.

### DETAILED DESCRIPTION OF THE PREFERRED EMBODIMENTS

An embodiment of the present invention is described below by referring to the drawings.

(Method of Manufacturing a Glass Substrate with a Through Hole According to Related Art)

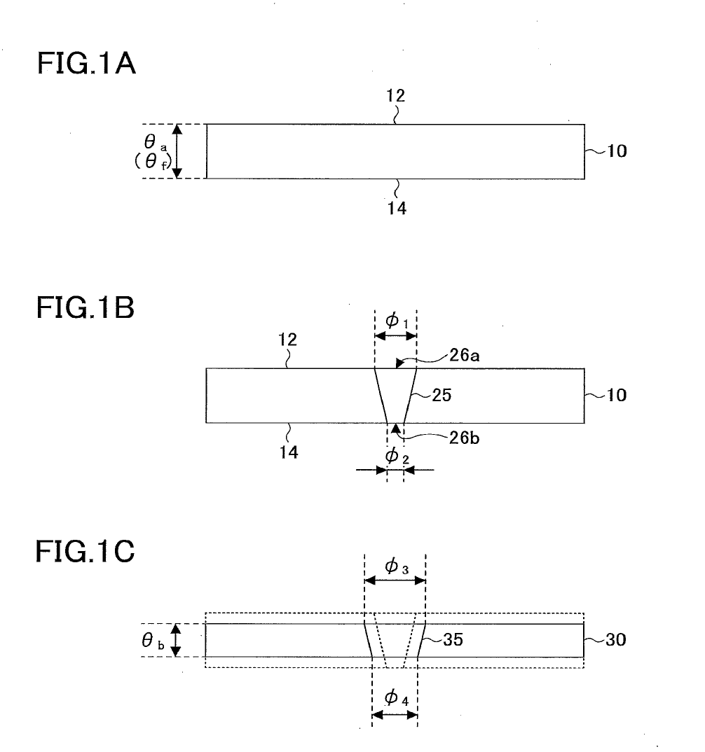

First, to facilitate better understanding of features of the present invention, a method of manufacturing a glass substrate with a through hole according to related art is briefly described by referring to FIG. 1.

FIG. 1 schematically illustrates each process of the method of manufacturing the glass substrate with the through hole according to the related art.

A usual method of manufacturing the glass substrate with the through hole (which is referred to as the “usual method,” hereinafter) includes, in general, (1) a process of preparing a glass substrate having first and second surfaces, and a first thickness (a first process); (2) a process of forming a through hole by irradiating a laser beam from the first surface of the glass substrate (a second process); and (3)a process of wet etching the glass substrate with the through hole to enlarge the size of the through hole (a third process).

First, in the first process, as illustrated in FIG. IA, a glass substrate 10 having a first surface 12 and a second surface 14 is prepared. The glass substrate 10 has a thickness of θₐ. The thickness θₐ of the glass substrate 10 is set to be a final thickness target value θ_{f} (θₐ=θ_{f}, accordingly) of the glass substrate with the through hole.

Next, in the second process, as illustrated in FIG. 1B, one or more through holes 25 are formed in the glass substrate 10. The through hole 25 is formed by irradiating a laser beam from the side of the first surface 12 of the glass substrate 10.

Note that, for a usual case, the through hole 25 is formed to have a tapered shape such that the diameter is reduced from the first surface 12 toward the second surface 4 in the glass substrate 10. The diameter of an opening (the first opening) 26a of the through hole 25 on the first surface 12 of the glass substrate 10 is denoted by φ₁; and the diameter of an opening (the second opening) 26b of the through hole 25 on the second surface 14 of the glass substrate 10 is denoted by φ₂.

Usually, a case may often arise where the diameter of the through hole 25 does not reach a predetermined size only by processing by a laser beam. For such a case, the following third process is to be performed.

In the third process, the glass substrate 10 is wet etched; and by doing this, the size of the through hole 25 is enlarged. For example, in the example illustrated in FIG. 1C, the through hole 25 is altered into the through hole 35 by the wet etching of the glass substrate 10. Namely, the size of the first opening 26a of the through hole 25 is enlarged from φ₁ to φ₃; and the size of the second opening 26b of the through hole 25 is enlarged from φ₂ to φ₄.

In this manner, the glass substrate 30 can be manufactured, which is provided with the through hole 35 having a desired size.

Note that, in order to omit the third process, it can be considered to directly form, in advance, a through hole (the through hole 35) having a predetermined size by laser processing in the second process. However, if the through hole having such a large size is directly formed by laser irradiation, a likelihood that a crack is generated in the glass substrate 10 is increased, so that the yield rate for manufacturing is lowered. Accordingly, it is not realistic to omit the third process, from the perspective of productivity.

Here, in the usual method, the glass substrate 10 itself is etched by the third process, so that the thickness is reduced from θₐ to θ_{b}. For this reason, a problem is that the thickness θ_{b} of the glass substrate 30 after manufacturing is less than θ_{f}, which is the target value.

Here, an amount of change of the thickness of the glass substrate 10 by etching is not so large; and the amount of change of the thickness is, for example, an Order of several tens of μms. Consequently, there have been not so many cases, so far, where the problem with the change of the thickness of the glass substrate 10 is revealed.

However, a glass substrate with a through hole is used, for example, for a glass interposer of a semiconductor element. In this field, in recent years, high dimensional accuracy has been required for the glass substrate and the through hole; and the required dimensional accuracy is often in the order of several tens of μms. Thus, even for a shift whose level is in the order of several tens of micrometers, it has become necessary to take a measure.

(Method of Manufacturing the Glass Substrate with the Through Hole According to an Embodiment of the Present Invention)

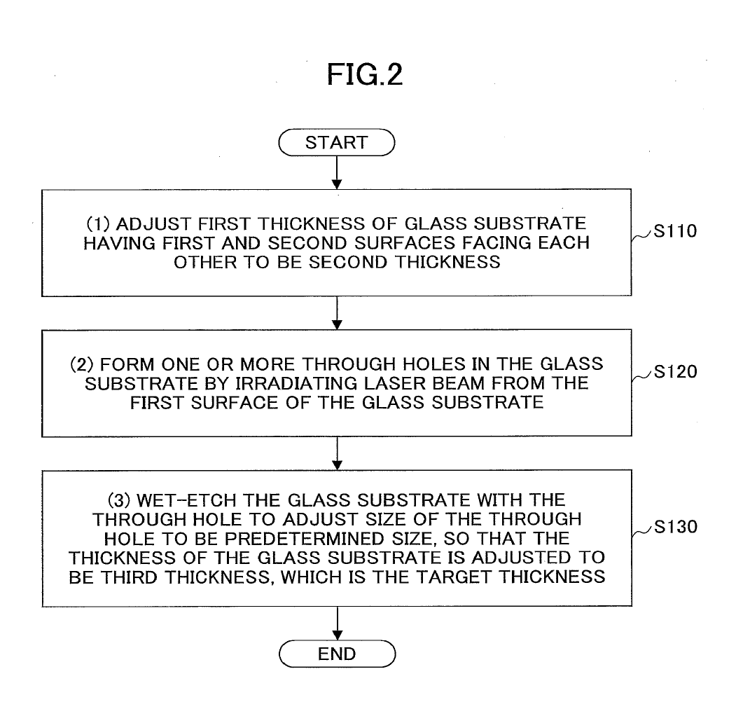

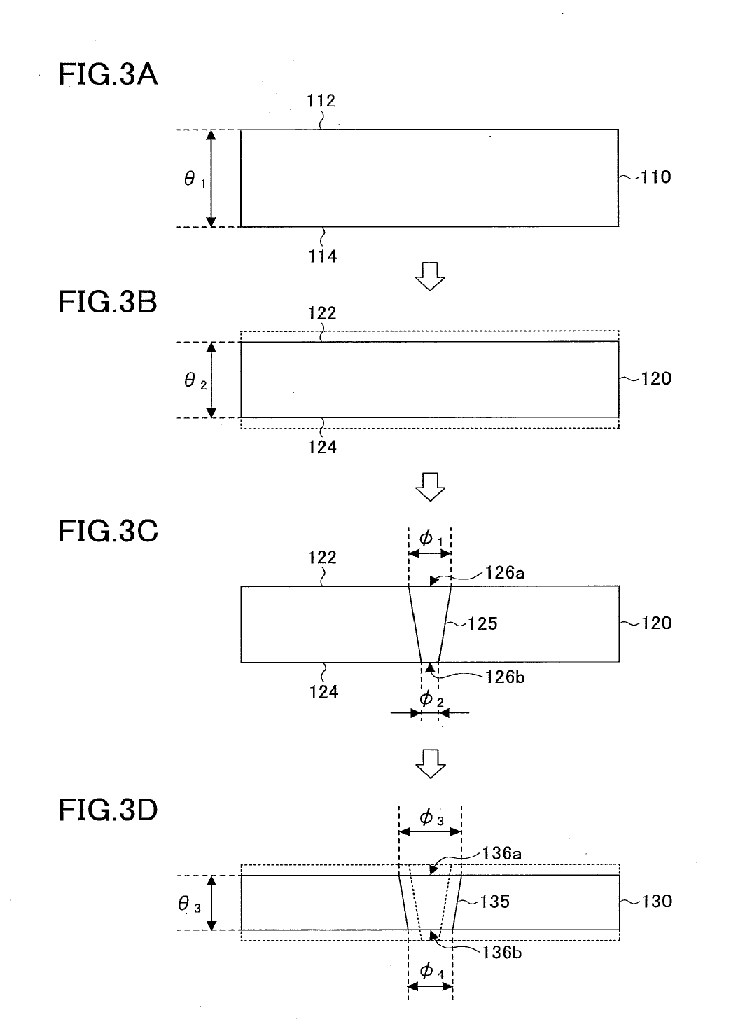

Next, an example of a method of manufacturing the glass substrate with the through hole according to the embodiment is described by referring to FIG. 2 and FIGS. 3A-3D.

FIG. 2 schematically illustrates a flow of the method of manufacturing the glass substrate with the through hole according to the embodiment of the present invention. Further, FIGS. 3A-3D schematically illustrate each process of the method of manufacturing the glass substrate with the through hole according to the embodiment of the present invention.

As illustrated in FIG. 2, the method of manufacturing the glass substrate with the through hole according to the embodiment of the present invention (which is referred to as the first manufacturing method, hereinafter) includes, in the following order, (1) a process of adjusting a first thickness of the glass substrate having first and second surfaces facing each other to be a second thickness (step S110); (2) a process of forming one or more through holes in the glass substrate by irradiating a laser beam from the first surface of the glass substrate (step S120); and (3) a process of wet-etching the glass substrate with the through hole to adjust a size of the through hole to be a predetermined size, so that the thickness of the glass substrate is adjusted to be a third thickness, which is the target thickness (step S130).

In the following, each process is described in detail by referring to FIGS. 3A-3D.

(Step S110)

First, as illustrated in FIG. 3A, a glass substrate 110 is prepared. The glass substrate 110 includes a first surface 112 and a second surface 114. In addition, the glass substrate 110 has a first thickness θ₁.

The first thickness θ₁ is not particularly limited; however, the first thickness θ₁ may be, for example, in a range from 300 μm to 1000 μm.

Note that, if the target value of the final thickness of the glass substrate with the through hole is θ_{f}, θ₁ is greater than θ_{f}.

Subsequently, as illustrated in FIG. 3B, the thickness of the glass substrate 110 is adjusted from the first thickness θ₁ to the second thickness θ₂.

The method of adjusting the thickness is not particularly limited. For example, the thickness may be adjusted by mechanical polishing at least one surface of the glass substrate 110 (the first surface 112 and/or the second surface 114). Alternatively, the thickness may be adjusted by wet etching the glass substrate 110. The condition of the wet etching is not particularly limited, as long as the glass substrate 110 can be etched. For an etchant, an aqueous solution of hydrofluoric acid may be used, for example.

By doing this, the glass substrate 120 having the second thickness θ₂ is obtained. The glass substrate 120 includes a first surface 122 and a second surface 124.

Note that, in the example of FIG. 3B, the glass substrate 110 is thinned from both surfaces (the first surface 112, and the second surface 114), so that the thickness becomes the second thickness θ₂. Consequently, the first surface 122 and the second surface 124 are newly formed surfaces.

However, this is merely an example, and the first surface 122 of the glass substrate 120 may be the same as the first surface 112 of the glass substrate 110, prior to the adjustment of the thickness. Alternatively, the second surface 124 of the glass substrate 120 may be the same as the second surface 114 of the glass substrate 110, prior to the adjustment of the thickness. Namely, the glass substrate 110 may be thinned from one of the surfaces.

The difference between the first thickness θ₁ and the second thickness θ₂ may be, for example, in a range from 5 μm to 500 μm. The difference between the first thickness θ₁ and the second thickness θ₂ is preferably from 7 μm to 100 μm; and more preferably from 10 μm to 50 μm. Since the cross-sectional shape of the hole becomes favorable, it is preferable that the glass substrate 110 be thinned to the extent of the above-described range.

Note that, for the second thickness θ₂, θ₂ is yet greater than θ_{f}.

(Step S120)

Next, by irradiating a laser beam from the first surface 122 of the glass substrate 120, one or more through holes are formed in the glass substrate 120.

The type and the irradiation condition of the laser beam are not particularly limited, as long as the one or more through holes can be formed in the glass substrate 120. For example, the laser beam may be a CO₂ laser beam, or a UV laser beam.

FIG. 3C illustrates a state where a through hole 125 is formed in the glass substrate 120.

A diameter of an opening (a first opening) 126a of the through hole 125 on the first surface 122 of the glass substrate 120 is denoted by φ₁; and a diameter of an opening (second opening) 126b of the through hole 125 on the second surface 124 of the glass substrate 120 is denoted by φ₂. As described above, for a usual case, the through hole 125 has a tapered shape. Accordingly, φ1 is greater than φ₂.

In the through hole 125, the diameter φ₁ of the first opening 126a is, for example, in a range from 1 μm to 200 μm; preferably from 3 μm to 150 μm; and more preferably from 5 μm to 100 μm. For example, by using a CO₂ laser beam, the first opening 126a having the diameter φ₁ from 50 μm to 100 μm can be easily formed.

Additionally, by using a UV laser beam, the first opening 126a having the diameter φ₁ from 5 μm to 20 μm can be easily formed.

The diameter φ₂ of the second opening 126b is, for example, in a range from 1 μm to 100 μm; preferably from 1 μm to 45 μm; and more preferably from 1 μm to 35 μm. For example, by using the CO₂ laser beam, the second opening 126b having the diameter φ₂ from 30 μm to 45 μm can be easily formed. Additionally, by using the UV laser beam, the second opening 126b having the diameter φ₂ from 1 μm to 5 μm can be easily formed.

Note that, in FIG. 3C, only the single through hole 125 is illustrated; however, a plurality of through holes may be formed in the glass substrate 120.

(Step S130)

Subsequently, the glass substrate 120 in which the through hole 125 is formed is wet etched. Consequently, the size of the through hole 125 is enlarged.

FIG. 3D illustrates a state where the through hole 125 is altered into the through hole 135 by the wet etching of the glass substrate 120.

By wet etching the glass substrate 120, the glass substrate 130 is obtained. In the glass substrate 130, the through hole 135 is formed to have a shape including a first opening (a third opening) 136a having a diameter of φ₃; and a second opening (a fourth opening) 136b having a diameter of φ₄. Namely, by wet etching the glass substrate 120, the diameter of the first opening 126a of the through hole 125 is enlarged from φ₁ to φ₃; and the diameter of the second opening 126b of the through hole 125 is enlarged from φ₂ to φ₄, thereby obtaining the through hole 135. The condition of the wet etching is selected, so that these sizes φ₃ and φ₄ are in a predetermined range.

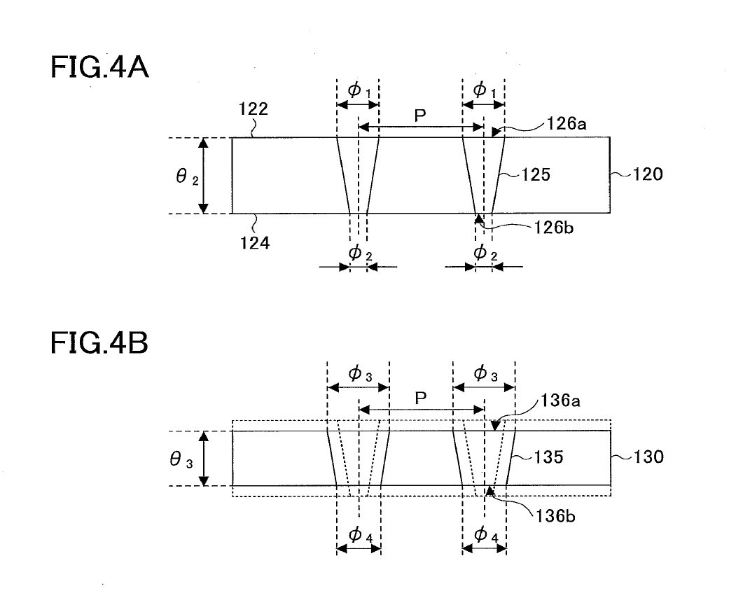

For a usual case, as illustrated in FIGS. 4A and 4B, the range of the size of the first opening 136a of the through hole 135 by wet etching is determined by a center-to-center distance P of the through holes 135 adjacent to each other, and the diameter φ₁ of the first opening 126a Namely, the range is such that (P−φ₃) is greater than zero.

Other conditions of the wet etching are not particularly limited, as long as the above-described range of the size is satisfied. For an etchant, an aqueous solution of hydrofluoric acid can be used, for example. Additionally, an etchant that is the same type as that of step S110 may be used.

In this manner, the glass substrate 130 can be manufactured, which is provided with the through hole 135 having a desired size.

Note that, by wet etching, the glass substrate is thinned, so that the second thickness θ₂ is reduced to be the third thickness θ₃. Namely, after the etching process to adjust the size of the through hole 135 to be the desired size, the thickness of the glass substrate 130 becomes the third thickness θ₃.

Here, in the first manufacturing method, the thickness of the glass substrate 110 is adjusted, at step S110, from the first thickness θ₁ to the second thickness θ₂. Therefore, if the adjusted amount of the thickness at this time (the second thickness θ₂) is adjusted, in advance, for example, to be the difference between the second thickness θ₂ and the third thickness θ₃, the third thickness θ₃ of the glass substrate 130 that is obtained after the wet etching at step S130 can be matched with the target thickness θ_{f}.

Consequently, according to the first manufacturing method, a problem, such as the problem of the related art, can be avoided such that, after performing the process of adjusting the size of the through hole (step S130), the thickness of the glass substrate is deviated from the target thickness θ_{f}.

Note that a process of thermal processing (S140) may be provided between the process of forming the through hole (S120) and the process of adjusting the size of the through hole (S130).

The temperature of the thermal processing is, for example, preferably from 60° C. to 800° C.; more preferably from 500° C. to 750° C.; and particularly preferably from 700° C. to 720° C. The time period of the thermal processing is preferably from 1 hour to 48 hours;

more preferably from 5 hours to 24 hours; and particularly preferably from 10 hours to 20 hours. A thermal processing atmosphere may be nitrogen or the air.

Further, in the first manufacturing method, the following problem that may be arise in the usual method can be significantly resolved. Namely, in the usual method, in order to avoid the problem that, after performing the process of adjusting the size of the through hole 25 (the third process), the thickness θ_{b} of the glass substrate 30 is deviated from the target thickness θ_{f}, it is required to directly form, at the second process, the through hole 35 with a desired size by laser processing. In this case, by application of large energy to the glass substrate 10, the likelihood that a crack is generated in the glass substrate 10 is increased. In contrast, in the first manufacturing method, the process of wet etching the glass substrate (step S130) after forming the through hole is not omitted, so that the above-described problem may not arise.

In the first manufacturing method, by these features, a glass substrate that is provided with a through hole with a desired size, and that has a desired thickness can be manufactured with a high yield rate.

### EXAMPLES

Examples of the method of manufacturing the glass substrate with the through hole are described below.

### Example 1

### Usual Method

A glass substrate with a through hole was manufactured by the following procedure.

First, a plurality of glass substrates was prepared, where each of the glass substrates had a thickness of 300 μm. Subsequently, for each glass substrate, a through hole was formed by irradiating a laser beam. For the laser source, a CO₂ laser source was used; and the laser beam was irradiated onto the first surface of the glass substrate with output power of 100 W.

In this manner, the through holes were formed in the glass substrates. The size of the opening (the diameter of the first opening) φ₁ of the through hole on the first surface was approximately 74 μm; and the size of the opening (the diameter of the second opening) φ₂ of the through hole on the second surface was approximately 40 μm.

Subsequently, in order to enlarge the through holes, each glass substrate was wet etched. As an etchant, a hydrofluoric acid solution was used.

By varying the condition of etching, the glass substrates having through holes with various sizes were obtained.

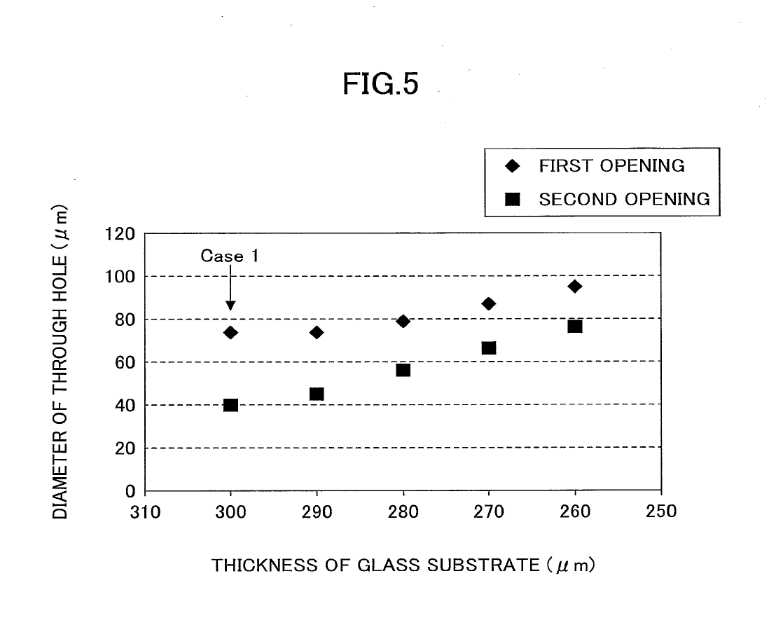

FIG. 5 collectively shows the relationship between the diameters of the first and second openings of the through hole of each glass substrate that was obtained after application of wet etching and the thickness of the glass substrate. In FIG. 5, the horizontal axis indicates the thickness of the glass substrate after applying wet etching; and the vertical axis indicates the size of the opening of the through hole. Note that case 1 indicates a state of the glass substrate, prior to applying wet etching.

From FIG. 5, it can be seen that, when the size of the through hole was enlarged by wet etching, the thickness of the glass substrate tends to decrease accordingly. Especially, for the case where the diameter φ₂ of the second opening is enlarged from approximately 40 μm to approximately 80 μm, the thickness of the glass substrate was decreased from 300 μm, which was prior to etching, to 260 μm.

In this manner, it can be said that, in the usual method, it is highly likely that the final thickness of the glass substrate is deviated from 300 μm, which is the target value.

### Example 2

A glass substrate with a through hole was manufactured by the first manufacturing method, such as that of illustrated in FIG. 2.

First, a glass substrate having a thickness (θ₁) of 400 μm was prepared. Subsequently, the glass substrate was wet etched, and the thickness (θ₂) was adjusted to be 338 μm (the first etching process). As an etchant, a hydrofluoric acid solution was used.

Subsequently, a through hole was formed in the glass substrate by irradiating a laser beam. The condition of processing was the same as that of above-described example 1. In this manner, the through hole was formed in which the diameter θ₁ of the first opening on the first surface was approximately 75 μm, and the diameter φ₂ of the second opening on the second surface was approximately 35 μm.

Subsequently, in order to enlarge the size of the through hole, the glass substrate was wet etched (the second etching process). As an etchant, the solution was used that was the same as the etchant used for the first etching process.

After etching, the diameter φ₁ (the diameter of the first opening after the second etching process is denoted as φ₃, hereinafter) of the first opening of the through hole was 95 μm, and the diameter φ₂ (the diameter of the second opening after the second etching process is denoted as φ₄, hereinafter) of the second opening of the through hole was 70 μm. Further, the thickness (θ₃=θ_{f}) of the glass substrate was 300 μm.

Here, the ratio of the change in the size of the first opening of the through hole by the second etching process was (95 μm−75 μm)/95 μm≈21%. Additionally, the ratio of the change in the size of the second opening of the through hole was (70 μm−35 μm)/70 μm=50%.

Table 1 below collectively shows variations in the thickness of the glass substrate and in the size of the through hole for each process of example 2.

TABLE 1

| | | After | | | | | |
|---|---|---|---|---|---|---|---|
| | | first | After forming the | | After the second etching | | |
| | | etching | through hole | | process | | |
| | Initial | process | diameter | diameter | | diameter | diameter |
| | thickness | thickness | of the | of the | thickness | of the | of the |
| | of glass | of glass | first | second | of glass | first | second |
| | substrate | substrate | opening | opening | substrate | opening | opening |
| Example | (μm) | (μm) | (μm) | (μm) | (μm) | (μm) | (μm) |
| 2 | 400 | 338 | 75 | 35 | 300 | 95 | 70 |

The ratio between the first etching process and the second etching process was obtained by the following procedure of (I) through (VI).

(I) Calculate a candidate of an etching amount (θ₂−θ₃) of the second etching process from the target value of the diameter φ₄ of the second opening (a final target lower hole diameter).

(I-1) Obtain a relational expression A between a change in the size of the diameter φ₂ of the second opening (the change from φ₂ to φ₄) and a decreased amount of the thickness of the glass substrate (the amount of etching), due to the second etching. For example, in example 2, prior to the second etching (and after the first etching), the second opening can be formed to have the diameter φ₂, which can be any size approximately from 20 μm to 55 μm, depending on an irradiation time period of the laser beam. Here, as a practical size of the diameter φ₂ of the second opening, the cases of the three patterns were examined, which were approximately 30 μm, approximately 35 μm, and approximately 40 μm. As the relational expression A, for the cases where φ₂ was approximately 30 μm, approximately 35 μm, and approximately 40 μm, a formula A(1), a formula A(2), and a formula A(3) were obtained from Table 2, respectively.

y₁=0.9431 x₁−23.096; The formula A(1):

y₁=0.9431 x₁−27.811; The formula A(2):

and

y₄=0.9431 x₁−32.527, the formula A(3):

where y₁ is the etching amount (θ₂−θ₃) of the second etching process, and x₁ is the diameter φ₄ of the second opening.

TABLE 2

| | Diameter φ₄ of the second | | |
|---|---|---|---|
| | opening after the second etching | | |
| Etching amount | A(1) | A(2) | A(3) |
| (θ₂ − θ₃) | φ₂ = 30 μm | φ₂ = 35 μm | φ₂ = 40 μm |
| 0 μm | 30 μm | 35 μm | 40 μm |
| 10 μm | 35 μm | 40 μm | 45 μm |
| 20 μm | 46 μm | 51 μm | 56 μm |
| 30 μm | 56 μm | 61 μm | 66 μm |
| 40 μm | 67 μm | 72 μm | 77 μm |

(I-2) Obtain the etching amount (θ₂−θ₃) of the second etching process from the above-described relational expression A. For example, in example 2, since the target value of φ₄=70 μm, from the formula A(1) where φ₂=30 μm, θ₂−θ₃=43 μm is obtained. From the formula A(2) where φ₂=35 μm, θ₂−θ₃=38 μm is obtained. From the formula A(3) where φ₂=40 μm, η₂−θ₃=33 μm is obtained.

(II) Calculate, from the target value of the thickness θᵣ of the glass substrate that is finally obtained (the final target plate thickness), a candidate of the thickness θ₂ of the glass substrate prior to the second etching process (after the first etching process). For example, in example 2, the target value of θ_{f} is 300 μm. In order to match θ₃ with the target thickness of θ_{f}, for the case of the above-described formula A(1), θ₂=343 μm is obtained from θ₂−θ₃=43 μm, which is obtained in the above-described (I). For the case of formula A(2), θ₂=338 μm is obtained from θ₂−θ₃=38 μm, which is obtained in the above-described (I); and for the case of formula A(3), θ₂=333 μm is obtained from θ₂−θ₃=33 μm, which is obtained in the above-described (I).

(III) Calculate the diameter pᵢ of the first opening prior to the second etching process (and after the first etching process) at θ₂.

(III-1) Obtain the relative expression between θ₂ and φ₁. For example, in example 2, there are cases where θ₂=343 μm, θ₂=338 μm, and θ₂=333 μm. As the relational expression B, for the cases where θ₂=343 μm, θ₂=338 μm, and θ₂=333 μm, a formula B(1), a formula B(2), and a formula B(3) were obtained from Table 3, respectively.

y₂=0.068 x₂+50.2; The formula B(1):

y₂=0.063 x₂+53.3; and the formula B(2):

y₂=0.057 x₂+56.9, the formula B(3):

where y₂ is the diameter φᵢ of the first opening after the first etching process, and x₂ is the thickness θ₂ of the glass substrate after the first etching process.

TABLE 3

| Second | | | | | |
|---|---|---|---|---|---|
| opening φ₂ | Diameter φ₁ of the first | | | | |
| prior to the | opening prior to the second etching | | | | |
| second | θ₂ = | θ₂ = | θ₂ = | | |
| etching process | 100 μm | 200 μm | 300 μm | θ₂ = 400 μm | θ₂ = 500 μm |
| B(1) 30 μm | 56 μm | 65 μm | 71 μm | 77 μm | 84 μm |
| B(2) 35 μm | 59 μm | 67 μm | 72 μm | 78 μm | 85 μm |
| B(3) 40 μm | 63 μm | 68 μm | 74 μm | 79 μm | 86 μm |

(III-2) Obtain the diameter φ₁ of the first opening formed by irradiation of the laser beam from the above-described relational expression B. For example, for the case of the formula B(1), θ₂=343 μm from the above-described (I) and (II), and φ₁=74 μm is obtained. For the case of the formula B(2), θ₂=338 μm from the above-described (I) and (II), and φ₁=75 μm is obtained. For the case of the formula B(3), θ₂=333 μm from the above-described (I) and (II), and φ₁=75 μm is obtained.

(IV) Calculate the diameter φ₃ of the first opening after the second etching process.

(IV-1) Obtain the relational expression between the etching amount (θ₂−θ₃) by the second etching process and the variation amount of the diameter of the first opening (the variation amount from φ₁ to φ₃). For example, in example 2, a formula C of Table 4 is obtained.

y₃=0.01 x₃²+0.24 x₃−3.5 The formula C:

Here, y₃ is the variation amount of the diameter of the first opening (the variation amount from φ₁ to φ₃: φ₃−φ₁), and x₃ is the etching amount (θ₂−θ₃) by the second etching process.

TABLE 4

| Etching amount | Variation amount of the diameter of the first opening |
|---|---|
| (θ₂ − θ₃) | after the second etching process (φ₃ − φ₁) |
| 0 μm | 0 μm |
| 10 μm | 0 μm |
| 20 μm | 5 μm |
| 30 μm | 13 μm |
| 40 μm | 22 μm |

(IV-2) From the above-described formula C, the amount of change (φ₃−φ₁) of the diameter of the first opening by the etching amount θ₂−θ₃ in the second etching process is obtained. For the case were θ₂−θ₃=43 μm, φ₃−φ₁ is 25 μm; and the diameter φ₁ of the first opening prior to the second etching process is 74 μm from the above-described (III), so that it is obtained that φ₃ is 25 μm+74 μm=99 μm. For the case were θ₂−θ₃=38 μm, φ₃−φ₁ is 20 μm; and the diameter φ₁ of the first opening prior to the second etching process is 75 μm from the above-described (III), so that it is obtained that φ₃ is 20 μm+75 μm=95 μm. For the case were θ₂31 θ₃=33 μm, φ₃−φ₁ is 15 μm; and the diameter φ₁ of the first opening prior to the second etching process is 75 μm from the above-described (III), so that it is obtained that φ₃ is 15 μm+75 μm=90 μm.

(V) Determine, from the target value of φ₃ (the diameter of the upper hole after the second etching process), the diameter φ₂ of the second opening (the diameter of the lower hole, prior to the second etching process) prior to the second etching process (and after the first etching process).

(V-1) For example, suppose that the target value of φ₃ is 95 μm. From the above-described (IV), θ₂−θ₃=38 μm is selected. From the above-described (I), for the diameter φ₂ of the second opening prior to the second etching process, 35 μm is selected.

(VI) Determine the first etching amount (θ₁−θ₂) from θ₂−θ₃, the thickness θ₁ of the glass substrate to be prepared, and the final target value θ_{f} for the thickness of the glass substrate (the final target plate thickness).

(VI-1) For example, in example 2, since θ₁=400 μm , θ_{f}=300 μm, and θ₂−θ₃=38 μm, it is obtained that θ₁−θ₂ is 400 μm−300 μm+38 μm=62 μm.

### Example 3

A glass substrate provided with a through hole was manufactured by the first manufacturing method, such as that of illustrated in FIG. 2.

First, a glass substrate having a thickness of 400 μm was prepared. Subsequently, the glass substrate was wet etched, and the thickness was adjusted to be 340 μm (the first etching process). As an etchant, a hydrofluoric acid solution was used.

Subsequently, a through hole was formed in the glass substrate by irradiating a laser beam. The condition of the processing was the same as that of the case of above-described example 1. In this manner, the through hole was formed where the diameter φ₁ of the first opening on the first surface was approximately 73 μm, and the diameter φ₂ of the second opening on the second surface was approximately 35 μm.

Subsequently, to enlarge the size of the through hole, the glass substrate was wet edged (the second etching process). As an etchant, the solution was used that was the same as the etchant used for the first etching process.

After etching, the diameter φ₁ of the first opening of the through hole was 101 μm, and the diameter φ₂ of the second opening of the through hole was 76 μm. Further, the thickness of the glass substrate was 300 μm.

Table 5 below collectively shows the variations in the thickness of the glass substrate and in the size of the through hole in each process of example 3.

TABLE 5

| | | After | After forming the | | | | |
|---|---|---|---|---|---|---|---|
| | | first | through hole | | After the second etching | | |
| | Initial | etching | | diameter | | | diameter |
| | thickness | thickness | diameter | of | thickness | diameter | of |
| | of glass | of glass | of first | second | of glass | of first | second |
| | substrate | substrate | opening | opening | substrate | opening | opening |
| Example | (μm) | (μm) | (μm) | (μm) | (μm) | (μm) | (μm) |
| 3 | 400 | 340 | 73 | 35 | 300 | 101 | 76 |

In this manner, in example 2 and example 3, the thickness of the glass substrate, which was obtained after enlarging the size of the through hole within a predetermined range, could be adjusted to be 300 μm, which was the target value.

The present invention can be utilized, for example, for a technique for forming a through hole in a glass substrate. Additionally, the present invention can be utilized, by forming a through electrode in the through hole of such a glass substrate, for a method of manufacturing the glass substrate provided with the through electrode, and for a method of manufacturing an interposer (a glass interposer).

The method of manufacturing the glass substrate with the through hole, the method of manufacturing the glass substrate including the through electrode, and the method of manufacturing the interposer are described by the embodiment. However, the method of manufacturing the glass substrate with the through hole, the method of manufacturing the glass substrate including the through electrode, and the method of manufacturing the interposer according to the present invention are not limited to the above-described embodiment, and various modifications and improvements may be made within the scope of the present invention.

What is claimed is:

1. A method of manufacturing a glass substrate with a through hole, the glass substrate having a thickness of θ_{f}, the method comprising:
(1) adjusting a first thickness θ₁ of the glass substrate having first and second surfaces facing each other to be a second thickness θ₂ (θ₂<θ₁);
(2) forming one or more through holes in the glass substrate by irradiating a laser beam from the first surface of the glass substrate; and
(3) wet-etching the glass substrate with the through hole to adjust a size of the through hole to be a predetermined size, so that the thickness of the glass substrate is adjusted from θ₂ to the target value of θ_{f}.

2. The method according to claim 1, wherein in the adjusting (1), the glass substrate is wet etched.

3. The method according to claim 2, wherein same types of etchants are used for the adjusting (1) and for the wet-etching (3).

4. The method according to claim 1, further comprising, between the forming (2) and the wet-etching (3) :
(4) thermal processing the glass substrate with the through hole.

5. The method according to claim 1, wherein a difference between the first thickness θ₁ and the second thickness θ₂ is in a range from 5 μm to 500 μm.

6. The method according to claim 1, wherein, by the forming (2), the through hole is formed, the through hole including a first opening having a diameter of φ₁ on the first surface and a second opening having a diameter of φ₂ on the second surface,
wherein, by the wet-etching (3), the through hole is formed, the through hole including a third opening having a diameter of φ₃ on the first surface and a fourth opening having a diameter of φ₄ on the second surface, and
wherein, φ₃>φ₁, and φ₄>φ₂ are satisfied.

7. The method according to claim 6, wherein, by the forming (2), a plurality of through holes are formed, and
wherein, in the wet-etching (3), when a center-to-center distance of two adjacent through holes is denoted by P, P−φ₃>0 is satisfied.

8. The method according to claim 6, wherein a candidate of the thickness (θ₂−θ_{f}) of the glass substrate, the thickness being adjusted at the wet-etching (3), is calculated from a target value of the diameter φ₄ of the fourth opening,
wherein a candidate of the second thickness θ₂ of the glass substrate obtained at the adjusting (1) is calculated from the target value θ_{f} of the thickness of the glass substrate,
wherein the diameter φ₁ of the first opening obtained at the forming (2) is calculated,
wherein the diameter φ₃ of the third opening obtained at the wet-etching (3) is calculated,
wherein the diameter φ₂ of the second opening obtained at the forming (2) is determined from the diameter φ₃ of the third opening, and
wherein the thickness of the glass substrate (θ₁−θ₂), the thickness being adjusted at the adjusting (1), is calculated from the thickness (θ₂−θ_{f}) of the glass substrate, the thickness being adjusted at the wet-etching (3), the first thickness θ₁ of the glass substrate, and the target value θ_{f} of the thickness of the glass substrate.

9. A method of manufacturing a glass substrate including a through electrode, the method comprising:
manufacturing the glass substrate with a through hole; and
forming the through electrode in the through hole,
wherein the glass substrate has a thickness of θ_{f}, and the manufacturing the glass substrate with the through hole includes
(1) adjusting a first thickness θ₁ of the glass substrate having first and second surfaces facing each other to be a second thickness θ₂ (θ₂<θ₁); (2) forming one or more through holes in the glass substrate by irradiating a laser beam from the first surface of the glass substrate; and
(3) wet-etching the glass substrate with the through hole to adjust a size of the through hole to be a predetermined size, so that the thickness of the glass substrate is adjusted from θ₂ to the target value of θ_{f}.

10. The method according to claim 9, wherein in the adjusting (1), the glass substrate is wet etched. 30

11. The method according to claim 10, wherein same types of etchants are used for the adjusting (1) and for the wet-etching (3). 5

12. A method of manufacturing an interposer, the method comprising:
manufacturing a glass substrate with a through hole; and
forming a through electrode in the through hole,
wherein the glass substrate has a thickness of θ_{f}, and the manufacturing the glass substrate with the through hole includes
(1) adjusting a first thickness θ₁ of the glass substrate having first and second surfaces facing each other to be a second thickness θ₂ (θ₂<θ₁);
(2) forming one or more through holes in the glass substrate by irradiating a laser beam from the first surface of the glass substrate; and
(3) wet-etching the glass substrate with the through hole to adjust a size of the through hole to be a predetermined size, so that the thickness of the glass substrate is adjusted from θ₂ to the target value of θ_{f}.

13. The method according to claim 12, wherein in the adjusting (1), the glass substrate is wet etched.

14. The method according to claim 13, wherein same types of etchants are used for the adjusting (1) and for the wet-etching (3).
